(19) United States
(12) Patent Application Publication
(10) Pub. No.: US 2024/0427288 A1
(43) Pub. Date: Dec. 26, 2024

(54) TIMEPIECE MOVEMENT

(71) Applicant: GREUBEL FORSEY S.A., La Chaux-de-Fonds (CH)

(72) Inventors: Stephen FORSEY, Les Brenets (CH); Florian CORNEILLE, Mathay (FR)

(21) Appl. No.: 18/694,148

(22) PCT Filed: Sep. 22, 2022
(86) PCT No.: PCT/EP2022/076392

§ 371 Date: Mar. 21, 2024

(30) Foreign Application Priority Data
Sep. 23, 2021 (EP) 21198580.9

(51) Int. Cl. G04B 1/22; G04B 15/10

(52) U.S. Cl. CPC G04B 1/22; G04B 15/10

(57) ABSTRACT

The invention relates to a timepiece movement (1) comprising:—a mechanical energy source (3);—a constant-force device (7) comprising an input wheel (11), arranged to be driven by said mechanical energy source (3), as well as an output wheel (13) kinematically connected to said input wheel (11) via a resilient element (9), which is preloaded and arranged to be recharged periodically on the basis of the rotation of said output wheel (13);—a regulating system (5) arranged to be driven by said output wheel (13). According to the invention, said movement (1) comprises:—an activation mechanism (29) arranged to be driven by said output wheel (13) and to drive a supplementary mechanism (27); and—a preload control system (23) arranged to modify said preload of said resilient member (9) on the basis of the state of said activation mechanism (29).

### TECHNICAL FIELD

The present invention relates to the field of timepieces. It relates more particularly to a timepiece movement comprising a constant-force mechanism and a disengageable additional mechanism, such as a chronograph mechanism, an animation, a striking mechanism, a countdown timer or similar.

### PRIOR ART

In order to minimize the variations in the torque received by the regulating system of a timepiece, a constant-force mechanism (also known as “remontoir”) is often incorporated into the kinematic chain linking the regulating system to the energy source, with the aim of improving isochronism.

These constant-force mechanisms comprise a force input driven by the energy source and a force output that is kinematically linked to the input by means of an elastic element. The elastic element is preloaded and is intermittently tensioned on rotation of the output. To this end, a blocking system is arranged to block the rotation of the input until the rotation of the output triggers the rotation of the input by a step having a predetermined angle.

As a result, it is only the torque supplied by the elastic element which drives the regulating system, this torque being relatively stable and independent of the torque supplied by the energy source (provided that the latter torque remains sufficiently high to recharge the elastic element).

A first classic version of such a constant-force mechanism is disclosed in CH296060. In this construction, the input and the output are coaxial and connected to each other by the elastic element. The input bears a satellite pinion that bears on a fixed toothing and is rigidly connected in rotation to a star, the star cooperating with a pin carried by the output such that the star is periodically blocked and released by the rotation of the output.

Another version of such a constant-force mechanism uses a system inspired by an escapement, comprising an anchor controlled by a cam to release the rotation of the input in function of the rotation of the output. An example of such a mechanism is disclosed in EP2166419. In this document, the watchmaker can easily modify the preload of the elastic element in order to optimize the torque available at the output.

However, when the movement comprises a disengageable additional mechanism, such as a chronograph mechanism, an animation, a striking mechanism, or similar, the torque requirement varies in function of the state of this additional mechanism.

One solution, proposed in CH716126, is to arrange the power take-off for the additional mechanism kinematically upstream of the constant-force mechanism. As a result, the state of the additional mechanism does not influence the torque supplied to the regulating system. However, this solution is only compatible with constant-force mechanisms with a relatively high release frequency of the input, otherwise the frequency of the rotation steps of the power take-off can be insufficient to operate the additional mechanism.

As an example, the case can be cited of a release frequency of the input of the constant-force device of one step every two seconds. Such an arrangement would not be suitable for a chronograph mechanism driven by a power take-off situated upstream of the constant-force mechanism, as a chronograph must have a time resolution of at least one second, ideally a fraction of a second.

The aim of the invention is therefore to propose a timepiece movement in which the aforementioned defects are at least partially overcome.

### DISCLOSURE OF THE INVENTION

More specifically, the invention relates to a timepiece movement as defined in claim 1. This movement comprises:
a mechanical energy source, such as one or more barrels housing one or more mainsprings;
a constant-force device of any type comprising an input mobile, arranged to be driven by said mechanical energy source, and an output mobile kinematically linked to said input mobile by means of an elastic element subjected to a preload and arranged to be recharged periodically in function of the rotation of said output mobile;
a regulating system, such as an escapement-balance-hairspring assembly arranged to be driven by said output mobile.

According to the invention, said movement comprises:
an activation mechanism, such as a clutch, arranged to be driven by said

output mobile and to drive an additional mechanism such as a chronograph, an animation, a striking mechanism, or similar; and
a preload control system arranged to modify said preload of said elastic element in function of the state of said activation mechanism.

By these means, the preload of the elastic element can be modified in function of the state of the activation mechanism, that is to say, in function of whether the additional mechanism is active or idle. This makes it possible to minimize the influence of the additional mechanism on the torque received by the regulating system, while making it possible for the additional mechanism to be situated kinematically downstream of the constant-force device, in particular through an increase in said preload when the additional mechanism is active. Isochronism is thus ensured.

Advantageously, said preload control system is arranged such that the angular relationship between one of the ends of said elastic element and either said input mobile or said output mobile can be modified in function of the state of said activation mechanism, which has the effect of modifying the preload, by partially arming or disarming the elastic element.

Advantageously, the kinematic link between said input mobile and said elastic element is provided by said preload control system. In particular, one end of said elastic element can be fixed to said output mobile, the other end of said elastic element being fixed to a control wheel arranged to be driven by said preload device.

Advantageously, the preload control system is arranged to form a kinematic link between said input mobile and said control wheel such that:
said control wheel can be driven synchronously with said input mobile during the normal operation of the movement, and
the angular relationship between said control wheel and said input mobile can be modified so as to vary the preload of the elastic element.

Advantageously, said preload control system comprises a differential gear comprising:
a first input arranged to be driven by said input mobile;
a second input arranged to be driven in function of the state of said activation mechanism; and
an output arranged to drive said control wheel.

Advantageously, said first input comprises a satellite-carrier mobile bearing a satellite pinion meshing both with a first sun wheel acting as said output and with a second sun wheel acting as said second input.

Advantageously, said output mobile is coaxial with said input mobile.

Advantageously, said input mobile is rigidly connected in rotation to a satellite-carrier mobile, the satellite-carrier mobile bearing a satellite pinion in mesh with a fixed toothing and rigidly connected in rotation to a star which cooperates with a pin borne by said output mobile so as to periodically release the rotation of said input. This arrangement therefore reproduces the operation of the mechanism proposed by CH296060.

The timepiece movement according to the invention can, of course, be incorporated into a timepiece.

### BRIEF DESCRIPTION OF THE DRAWINGS

Further details of the invention will become more clearly apparent on reading the following description, given with reference to the appended drawings, in which:

FIG. 1 is a schematic view of a timepiece movement according to the invention; and

FIG. 2 is a schematic view of part of the timepiece movement in FIG. 1, illustrating a particular embodiment of the preload control system.

### EMBODIMENT OF THE INVENTION

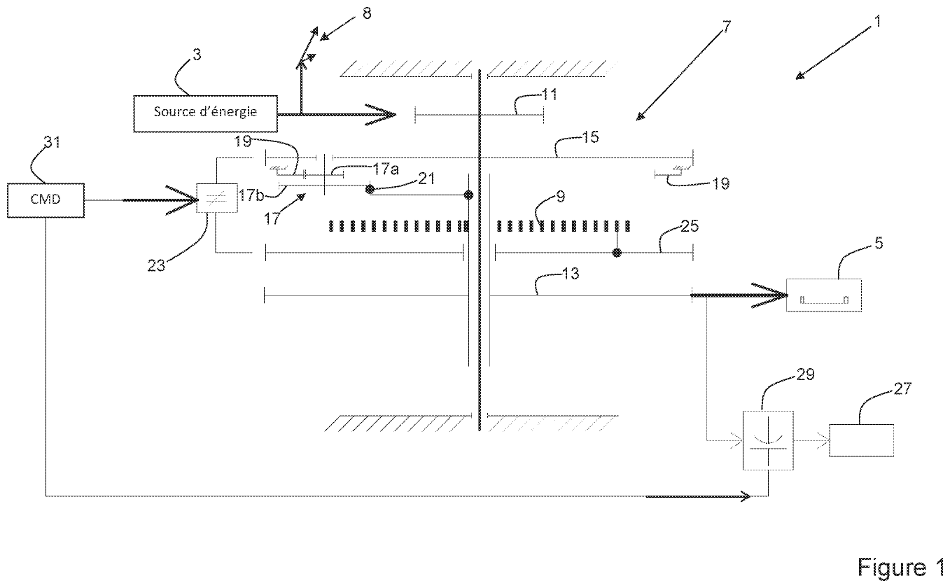

FIGS. 1 schematically illustrates a timepiece movement 1 according to the invention, kinematic links being mainly illustrated by arrows. Of course, the general knowledge of the person skilled in the art in the field of timepieces enable him to create such kinematic links by means of gears, gear trains, belts, chains, or any other appropriate means. In the present description, a kinematic link or an interconnection can be direct or indirect, and the illustrated arrangement should not be interpreted as being limiting.

The movement 1 comprises a mechanical energy source 3, such as one or more barrels, that drives a regulating system 5 such as an escapement-balance-hairspring assembly of any type, by means of an appropriate kinematic link. This kinematic link comprises a constant-force device 7, kinematically interposed between the energy source 3 and the regulating system 5. A display device 8 takes power from kinematic link in a known manner, this power take-off typically being situated kinematically upstream of the constant-force device 7. However, it cannot be excluded that the power take-off for all or part of the display device 8 be situated downstream of the constant-force device 8. For example, the power take-off for the seconds display could be arranged downstream, while the power take-off for the hours and minutes is situated upstream of the constant-force device.

In the illustrated embodiment, the constant-force device 7 is based on the device in CH296060, but the same principle can also apply to an “escapement” type constant-force device 7, such as for example the device in EP2166419, or to another kind of mechanism of this type.

In any event, the constant-force device 7 comprises an elastic element 9 that forms part of a kinematic link between, on the one hand an input mobile 11, which is directly or indirectly driven by the energy source, and on the other hand an output mobile 13, which is coaxial with said input mobile 11 and directly or indirectly drives the regulating system 5. The elastic element 9 is subjected to a preload and is arranged so as to be recharged periodically in function of the rotation of said output mobile 13, as mentioned in the introduction. The elastic element 9 is typically a spring in the form of a flat spiral, but can also be a leaf spring, helical spring, or similar.

In the illustrated embodiment, the constant-force device 7 comprises a satellite-carrier mobile 15 that is rigidly connected in rotation to the input mobile 11 (or alternatively acts as the input mobile 11 itself) and bears a satellite mobile 17 composed of a pinion 17a that meshes with a fixed toothing 19, and a star 17b that is rigidly connected in rotation to the pinion 17a. This star cooperates with a pin 21 that is rigidly connected in rotation to said output mobile 13, such that a rotation of said output mobile 13 by a predetermined angle, under the effect of the elastic element 9, releases the star 17b, which causes the rotation of the satellite-carrier mobile 15 and thus of the input mobile 11 by said predetermined angle, the next point of the star 17b being blocked again by the pin 21 when the star 17b rolls on the fixed toothing 19. CH296060 contains a detailed explanation of this functioning, in the context of a construction in which the elastic element 9 connects the input mobile 11 directly to said outlet mobile 13.

In the construction of CH296060, the preload of the elastic element 9 is fixed, and is predetermined by the watchmaker. Conversely, in the illustrated embodiment, this preload can be modified by means of a preload control system 23.

To this end, instead of being directly connected to the input mobile 11, one of the ends of the elastic element 9 is mounted on a control wheel 25 that is mounted idly in the constant-force device 7, the other end of the elastic element 9 being rigidly connected to the output mobile 13. In the illustrated embodiment, the outer end of the elastic element 9 is fixed to the control wheel 25, while the inner end is fixed to the output mobile 13, but the reverse configuration is also possible.

The preload control system 23 is arranged to form a kinematic link between the input mobile 11 and the control wheel 25 such that:
the control wheel 25 can be driven synchronously with the input mobile 11 during the normal operation of the movement, and
the angular relationship these two elements can be modified so as to vary the preload of the elastic element 9.

The aim of this preload control system 23 is to be able to compensate for the requirements (such as torque and force) necessary for the disengageable additional mechanism 27, which is situated kinematically downstream of the constant-force device 7. This additional mechanism 27 can be, for example, a chronograph mechanism, an animation mechanism, a striking mechanism, a countdown timer, or similar, driven by the output mobile 13 through an activation mechanism 29 of any known type, such as for example a clutch of any type (radial, vertical, sliding gear, etc.), a cam, a column-wheel, a spring armed for a certain length of time that releases at a given moment, or similar.

As the specific form of the activation mechanism 29 is a clutch 29 in the embodiment in FIG. 1, the specific term “clutch 29” is used hereinafter to denote the generic feature of an “activation mechanism 29”, in order to simplify reading.

By positioning the additional mechanism in this way, it can benefit from a relatively high angular velocity, the angular steps of which are independent of the constant-force device 7 and does not therefore depend on the frequency of the rotational steps of the star 17b.

However, the torque requirement downstream of the constant-force device 7 varies in function of the state of the additional mechanism 27. When this latter is not running and the clutch 29 is disengaged (more generally, when the activation mechanism 29 is in the deactivated state), the torque requirement is lower, and the torque supplied to the regulating system 5 is thus higher, the system essentially receiving all of the torque supplied by the constant-force device 7. The beat frequency and amplitude of its oscillator are therefore higher.

When the clutch 29 is engaged (more generally, when the activation mechanism 29 is in the activated state), the torque requirement is higher, and the torque available to drive the regulating system 5 is thus reduced as it is shared with the additional mechanism 27. The beat frequency and amplitude of the oscillator are thus reduced.

This situation is of course detrimental to isochronism, and reduces the positive effect of the constant-force device 7 when the additional mechanism is active.

The preload control system 23 makes it possible to compensate for this variation in torque requirement, by varying the preload of the elastic element 9 in function of this latter, in particular in function of the state of the clutch 29.

As a result, when the clutch 29 is disengaged, the control wheel 25 occupies a first relative angular position with respect to the input mobile 11, and the elastic element 9 is subject to a first predetermined preload.

When the clutch 29 is engaged, the control wheel 25 occupies a second relative angular position with respect to the input mobile 11, and the elastic element 9 is subject to a second predetermined preload, greater than said first preload.

In the illustrated variant, the control of the clutch 29 and of the preload control system 23 are effected in parallel, through a common control device 31. It is also possible to arrange the control of these two elements in series. In any event, the control device 31 ensures that the relative angular position of the control wheel 25 with respect to the input mobile (and therefore the preload of the elastic element 9) is modified in function of the state of the clutch. In addition, the control device 31 can be manual (actuated by a push-button, a bolt, or similar) or automatic (actuated by a mechanism internal to the movement 1).

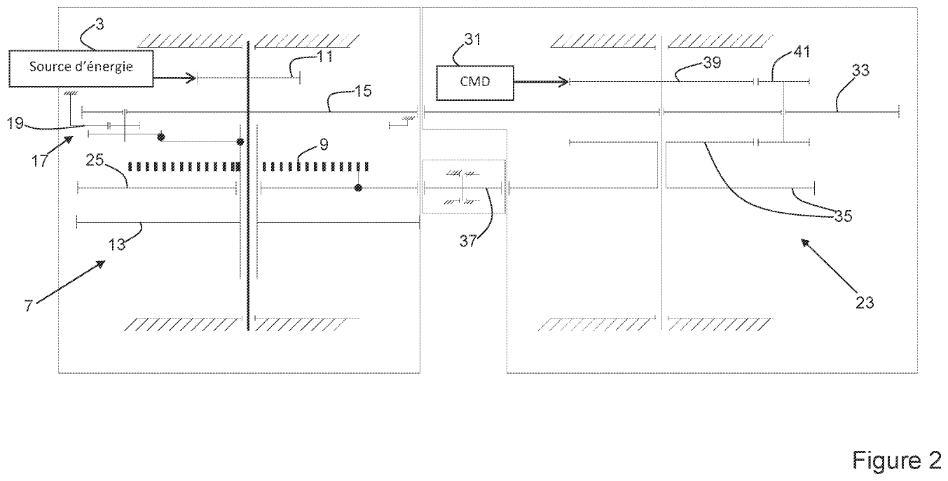

FIG. 2 illustrates a non-limiting way of modifying the preload of the elastic element 9, based on a differential gear. In order to simplify this figure, the elements situated kinematically downstream of the output mobile 13 have not been shown.

The preload control system 23 comprises a satellite-carrier mobile 33 (which is specific to it and is distinct from the satellite-carrier mobile 15 of the constant-force device 7) acting as a first input that meshes with the satellite-carrier mobile 15 of the constant-force device 7, and a first sun mobile 35 that is coaxial with the satellite-carrier mobile 33 and cooperates with the control wheel 25 by means of an intermediate inverter wheel 37. The first sun mobile 35 therefore acts as the output. A second sun mobile 39, acting as a second input and coaxial with the first 35, cooperates with the control device 31 on the one hand and with at least one satellite mobile 41, which meshes simultaneously with each of the sun mobiles 35, 39, on the other. Of course, the illustrated construction is not limiting, and the presence or absence of intermediate wheels between the elements of the constant-force device 7 and those of the preload control system 23 can be determined according to the constructor's requirements, provided that the gear ratios are appropriate.

During normal operation of the mechanism, the control device 31 maintains the second sun mobile 39 in a first predetermined angular position. The rotation of the satellite-carrier mobile 15 and therefore of the input mobile 11, which is rigidly connected to it in rotation, is thus transferred to the control wheel 25, the gear ratios being selected such that the angular velocities of these two elements are identical.

Upon actuation of the control device 31, which, it will be remembered, drives the engagement and disengagement of the clutch 29 and therefore the activation of the additional mechanism 27, the control device 31 rotates the second sun mobile in one direction or the other (as appropriate) to occupy a second predetermined angular position distinct from the first, by means of a cam, a lever, a rack, or any other suitable means. This rotation causes the satellite mobile 41 to rotate about its own axis of rotation and thus causes an additional rotation of the first sun mobile 35 by a predetermined angle in one direction or the other, which is thus added to or subtracted from the normal rotation. This additional rotation is transferred to the control wheel 25, and is added to or subtracted from the rotation received from the satellite-carrier mobile 15, thus modifying the angular relationship between these two elements and partially arming/disarming (as appropriate) the elastic element 9, the preload of which is thus modified.

Of course, other constructions of the preload control system 23 are possible and are within the reach of a person skilled in the art, and the same principle can apply to a constant-force device 7 of the type disclosed in EP2166419, or similar.

Although the invention has been described above with reference to specific embodiments, other additional variants can also be envisaged without departing from the scope of the invention as defined by the claims.

1. A timepiece movement comprising:
a mechanical energy source;
a constant-force device comprising an input mobile, arranged to be driven by said mechanical energy source, and an output mobile kinematically linked to said input mobile by means of an elastic element-subjected to a preload and arranged to be recharged periodically in function of the rotation of said output mobile;
a regulating system arranged to be driven by said output mobile;
wherein said movement comprises:
an activation mechanism arranged to be driven by said output mobile and to drive an additional mechanism; and
a preload control system arranged to modify said preload of said elastic element in function of the state of said activation mechanism.

2. The timepiece movement as claimed in claim 1, in which said preload control system is arranged such that the angular relationship between one of the ends of said elastic element and one of said input mobile-and said output mobile can be modified in function of the state of said activation mechanism.

3. The timepiece movement as claimed in claim 2, in which the kinematic link between said input mobile and said elastic element is provided by said preload control system.

4. The timepiece movement as claimed in claim 3, in which one end of said elastic element is fixed to said output mobile, the other end of said elastic element being fixed to a control wheel arranged to be rotated by said preload device.

5. The timepiece movement as claimed in claim 4, in which said preload control system is arranged to form a kinematic link between said input mobile and said control wheel such that:
said control wheel can be driven synchronously with said input mobile during the normal operation of the movement, and
the angular relationship between said control wheel and said input mobile can be modified so as to vary the preload of the elastic element.

6. The timepiece movement as claimed in claim 5, in which said preload control system comprises a differential gear comprising:
a first input arranged to be driven by said input mobile;
a second input arranged to be driven in function of the state of said activation mechanism; and
an output arranged to drive said control wheel.

7. The timepiece movement as claimed in claim 6, in which said first input comprises a satellite-carrier mobile bearing a satellite mobile meshing both with a first sun wheel, acting as said output, and with a second sun wheel, acting as said second input.

8. The timepiece movement as claimed in claim 1, in which said output mobile is coaxial with said input mobile.

9. The timepiece movement as claimed in claim 8, in which said input mobile is rigidly connected in rotation to a satellite-carrier mobile, the satellite-carrier mobile bearing a satellite pinion in mesh with a fixed toothing and rigidly connected in rotation to a star, the star cooperating with a pin borne by said output mobile so as to periodically release the rotation of said input.

10. The timepiece movement as claimed in claim 1, in which said activation mechanism is a clutch.

11. A timepiece comprising a timepiece movement as claimed in claim 10.
